(19) United States
(12) Patent Application Publication
(10) Pub. No.: US 2026/0254169 A1
(43) Pub. Date: Aug. 27, 2026

(54) CONNECTOR PIN MODULE FOR HIGH-FREQUENCY SIGNAL TRANSMISSION

(71) Applicant: CHROMA ATE INC., Taoyuan City (TW)

(72) Inventors: PO-KAI CHENG, Taoyuan City (TW); CING-WEI LU, Taoyuan City (TW)

(21) Appl. No.: 19/436,552

(22) Filed: Dec. 30, 2025

(30) Foreign Application Priority Data
Feb. 26, 2025 (TW) 114107157

(51) Int. Cl. H01R 13/6477; H01R 13/24

(52) U.S. Cl. CPC H01R 13/6477; H01R 13/2421; H01R 13/2471

(57) ABSTRACT

A connector pin module for high-frequency signal transmission is provided. The connector pin module includes a metal body and a plurality of signal transmitters. The metal body includes a plurality of channels extending therethrough, and the signal transmitters are disposed within the channels respectively. The signal transmitters each include a signal connector pin and a non-conductive dielectric. The non-conductive dielectric is arranged around the signal connector pin such that the signal connector pin is spaced apart from the wall surface of the channel. Accordingly, the connector pin module is arranged with a specific configuration and corresponding materials to reduce interference to signals and to avoid becoming a bottleneck in the improvement of transmission rate.

### BACKGROUND OF THE INVENTION

### FIELD OF THE INVENTION

The present disclosure relates to a connector pin module, and more particularly to a connector pin module for high-frequency signal transmission.

### DESCRIPTION OF THE PRIOR ART

In a signal transmission path, signals pass through various connector pin modules. The connector pin modules provide interconnection of transmission paths between different interfaces or devices.

As the demand for data transmission increases, higher frequencies are required to increase bandwidth and enable more data to be transmitted per unit time, thereby achieving higher transmission rates. However, such high frequency requirements cause conventional connector pin modules to become a limiting factor in enhancing transmission rates. This is because high-frequency signals, such as radio frequency (RF) signals, require precise impedance matching, and impedance matching may be affected by the configuration and combination of the transmission interfaces.

The elimination of various interferences along the signal transmission path often involves a complicated process. Although connector pin modules are merely interconnection interfaces, if the connector pin modules possess low-interference characteristics, the transmission of high-frequency signals can become more stable. Therefore, there is a need for a connector pin module for high-frequency signal transmission.

### SUMMARY OF THE INVENTION

In some embodiments disclosed herein, a connector pin module is provided with a configuration suitable for high-frequency signal transmission.

According to some embodiments, a connector pin module for high-frequency signal transmission comprises a metal body and a plurality of signal transmitters. The metal body comprises a plurality of channels extending therethrough. The signal transmitters are disposed within the channels respectively. The signal transmitters each comprise a signal connector pin and a non-conductive dielectric. The non-conductive dielectric is arranged around the signal connector pin such that the signal connector pin is spaced apart from the wall surface of the channel.

According to some embodiments, the metal body comprises a first body and a second body coupled to each other, with a first step portion defined on a wall surface of each of the channels of the first body, and a second step portion defined on a wall surface of each of the channels of the second body, the non-conductive dielectric being restrained by the first step portion to prevent upward detachment and being restrained by the second step portion to prevent downward detachment.

According to some embodiments, the first body has a periphery comprising an extension portion extending downward, and a recessed portion is defined at a bottom side of the first body by the extension portion such that the second body is disposed within the recessed portion.

According to some embodiments, the non-conductive dielectric comprises a protruding section on an upper surface of the first body, and the protruding section is supported by the second step portion against a downward pressing force from a contact plate disposed above the protruding section to maintain a predetermined distance between the first body and the contact plate.

According to some embodiments, each of the protruding sections protrudes from the upper surface of the first body by not more than 0.4 mm or by about 0.2 mm, or by 0.16 mm to 0.24 mm.

According to some embodiments, the non-conductive dielectric comprises a first dielectric portion disposed within the channel of the first body and a second dielectric portion disposed within the channel of the second body.

According to some embodiments, the non-conductive dielectric is made of a material comprising at least polytetrafluoroethylene (PTFE).

According to some embodiments, the metal body is made of brass or aluminum.

According to some embodiments, the connector pin module further comprises a plurality of ground connector pins, and the metal body further comprises a plurality of blind holes disposed around the channels respectively. The ground connector pins are disposed within the blind holes respectively and each comprise a telescopic portion protruding from the blind hole.

According to some embodiments, the blind holes each comprise an upper blind-hole portion disposed in the first body and extending therethrough and a lower blind-hole portion disposed in the second body and not extending therethrough.

According to some embodiments, the signal connector pin and ground connector pins are Pogo Pins.

Accordingly, the connector pin module is arranged with a specific configuration and corresponding materials to apply to the transmission of high-frequency signals and thus avoid becoming a bottleneck in the improvement of transmission rate.

### BRIEF DESCRIPTION OF THE DRAWINGS

FIG. 1 is a perspective view of a connector pin module according to some embodiments of the disclosure.

FIG. 2 is a top view of the embodiment shown in FIG. 1.

FIG. 3 is a cross-sectional view taken along line A–A of FIG. 2.

FIG. 4 is a cross-sectional view taken along line B–B of FIG. 2.

FIG. 5 is a partially enlarged schematic view based on FIG. 3.

### DETAILED DESCRIPTION OF THE EMBODIMENTS

Objectives, features, and advantages of the present disclosure are hereunder illustrated with specific embodiments, depicted with drawings, and described below.

In the disclosure, descriptive terms such as “a” or “one” are used to describe the unit, component, structure, device, module, portion, section or region, and are for illustration purposes and providing generic meaning to the scope of the present invention. Therefore, unless otherwise explicitly specified, such description should be understood as including one or at least one, and a singular number also includes a plural number.

In the disclosure, descriptive terms such as “include, comprise, have” or other similar terms are not for merely limiting the essential elements listed in the disclosure, but can include other elements that are not explicitly listed and are however usually inherent in the units, components, structures, devices, modules, portions, sections or regions.

In the disclosure, the terms similar to ordinals such as “first” or “second” described are for distinguishing or referring to associated identical or similar components or structures, and do not necessarily imply the orders of these components, structures, portions, sections or regions in a spatial aspect. It should be understood that, in some situations or configurations, the ordinal terms could be interchangeably used without affecting the implementation of the present invention.

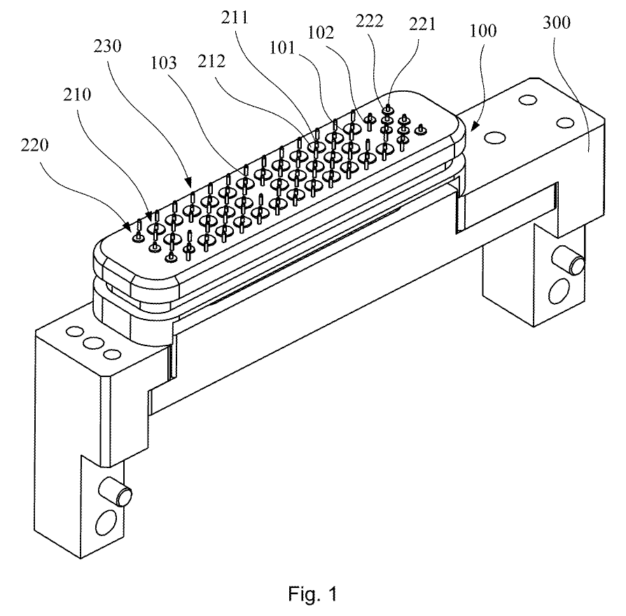

Referring to FIG. 1, there is shown a perspective view of a connector pin module according to some embodiments of the disclosure. The connector pin module is typically mounted on a support frame 300, and provides electrical connection terminals at its upper and lower sides for connection to corresponding components. That is, the connector pin module serves as a medium that provides electrical connection paths between devices, components, or other elements through its terminals.

For example, a carrier board (not shown) of a device under test positioned above the connector pin module is in contact with the connector pin module to form electrical connection. The carrier board is subjected to a downward pressing force to achieve stable electrical connection with the connector pin module. Meanwhile, the lower side of the connector pin module is electrically connected to a back-end control device through connecting to transmission lines or contacting another carrier board.

As illustrated by FIG. 1, the connector pin module comprises a metal body 100, a plurality of signal transmitters 210, a plurality of low-frequency signal transmitters 220, and a plurality of ground connector pins 230. The signal transmitters 210 each comprise a signal connector pin 211 and a non-conductive dielectric 212. The non-conductive dielectric 212 is arranged around the signal connector pin 211 to form a surrounding encapsulation. Likewise, the low-frequency signal transmitters 220 each comprise a non-conductive dielectric 222 arranged around a low-frequency signal connector pin 221. The ground connector pins 230 are evenly arranged in an array surrounding the signal transmitters 210.

As shown in FIG. 1, the non-conductive dielectrics 222 surrounding the signal connector pin 221 in the low-frequency signal transmitters 220 are thinner than the non-conductive dielectrics 212 surrounding the signal connector pins 211. It is because the low-frequency signal transmitters 220 are usually for use in transmitting low-frequency signals (e.g., hundreds of MHz or less) and require less stringent impedance matching; thus, the non-conductive dielectrics 222 can be thin to reduce overall volume. By contrast, the signal transmitters 210 are for use in transmitting high-frequency signals (for example, in the GHz range, such as 7.5 Gbps) and require precise impedance matching; thus, the thicker non-conductive dielectrics 212 are used in the configuration of the present disclosure. In addition, the ground connector pins 230 illustrated in FIG. 1 may optionally be omitted in some embodiments.

The non-conductive dielectrics 212, 222 are made of Teflon, i.e., polytetrafluoroethylene (PTFE), and are high-performance non-conductive dielectrics. However, in some other embodiments, other types of non-conductive dielectrics can be used.

In some embodiments of the present disclosure, the connector pin module comprises the metal body 100 and the plurality of signal transmitters 210. The metal body 100 comprises channels 101 extending therethrough. The signal transmitters 210 are disposed within the channels 101 respectively. The signal connector pins 211 are surrounded by the non-conductive dielectrics 212 and thereby spaced apart from the wall surface of the channels 101. The metal body 100 is made of brass or aluminum. With this basic structural configuration of the connector pin module, the signal connector pin 211 is effectively arranged within a metallic body. The diameter of the channels 101 and the matching non-conductive dielectrics 212 allow the impedance matching of the signal connector pins 211 to be precisely controlled, which in turn makes the connector pin module suitable for high-frequency signal transmission.

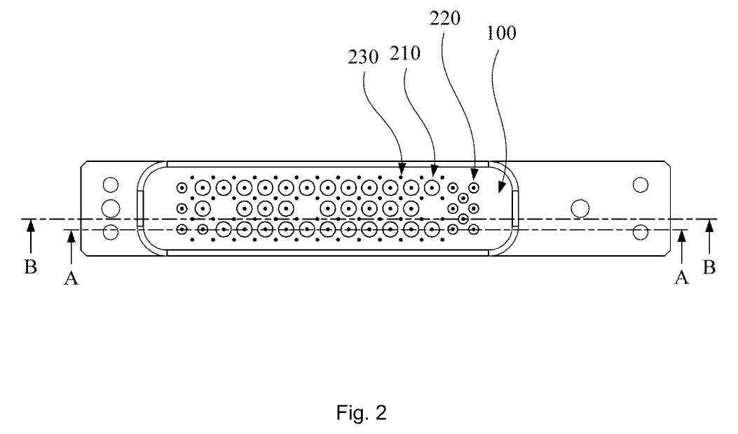

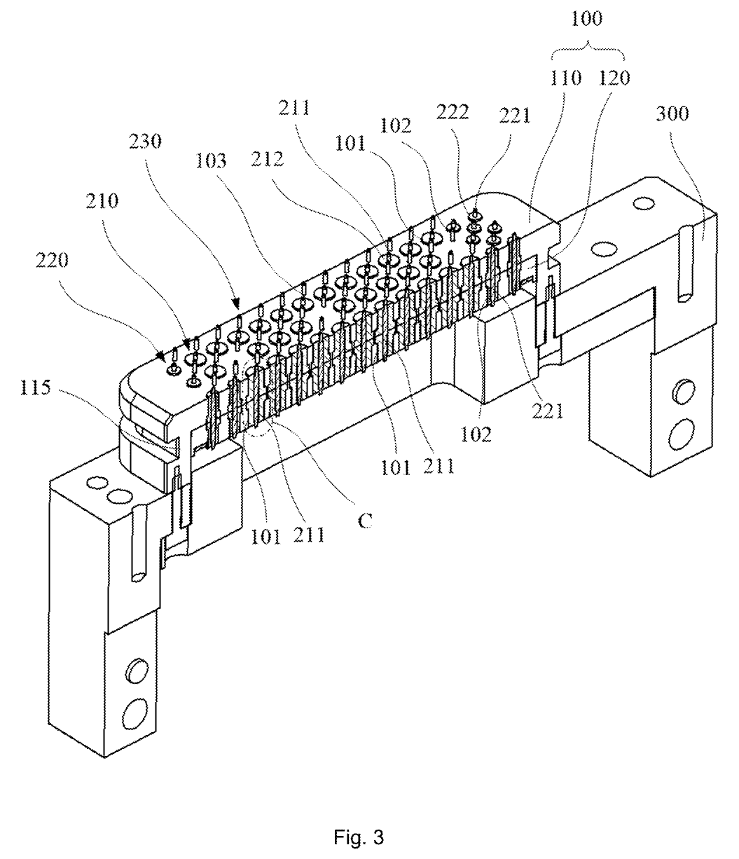

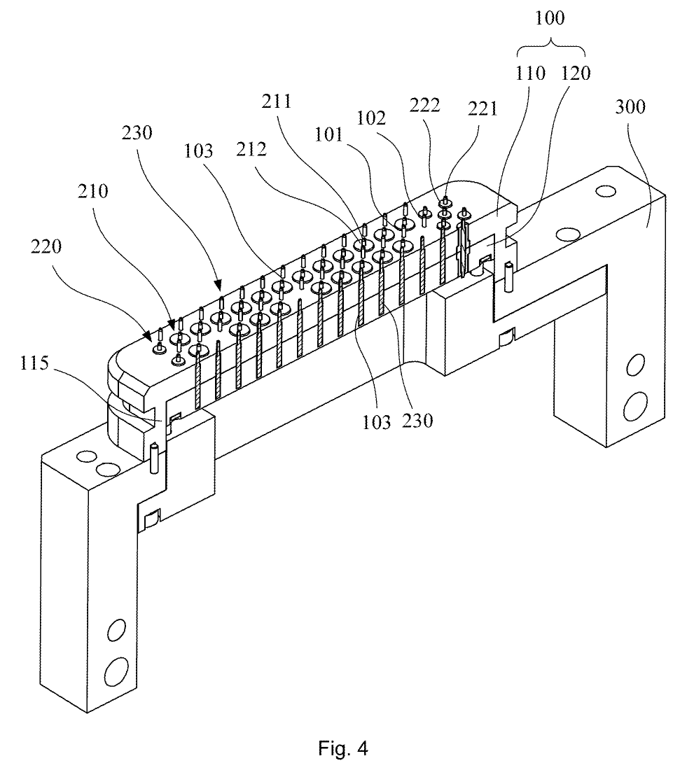

Referring to FIG. 1 through FIG. 4, there are shown in FIG. 2 a top view of the embodiment shown in FIG. 1, in FIG. 3 a cross-sectional view taken along line A–A of FIG. 2, and in FIG. 4 a cross-sectional view taken along line B–B of FIG. 2.

The metal body 100 is configured to comprise a first body 110 and a second body 120. The first body 110 and the second body 120 are coupled to each other. In the exemplary embodiments illustrated by FIG. 1 through FIG. 4, the second body 120 is configured to be embedded within the first body 110. This arrangement, wherein the first body 110 encloses the second body 120, serves to provide an increased area of coverage and shielding for the junction between the first body 110 and the second body 120. Such a configuration is beneficial for enhancing the quality of signal transmission. Moreover, approximately half of each channel 102 may be formed in the first body 110, and the remaining portion may be formed in the second body 120. In other embodiments, different allocation ratios may be implemented. Preferably, a majority portion (greater than 50%) of each channel 102 is formed within the first body 110 as compared to the second body 120. For example, based on the total depth of the channels 102, two-thirds of the depth is formed in the first body 110.

An extension portion 115 extending downwardly from a periphery of the first body 110 surrounds the second body 120. The extension portion 115 thereby defines a recessed portion on a bottom side of the first body 110, and the second body 120 is received and positioned within the recessed portion to be embedded into an inner side of the first body 110.

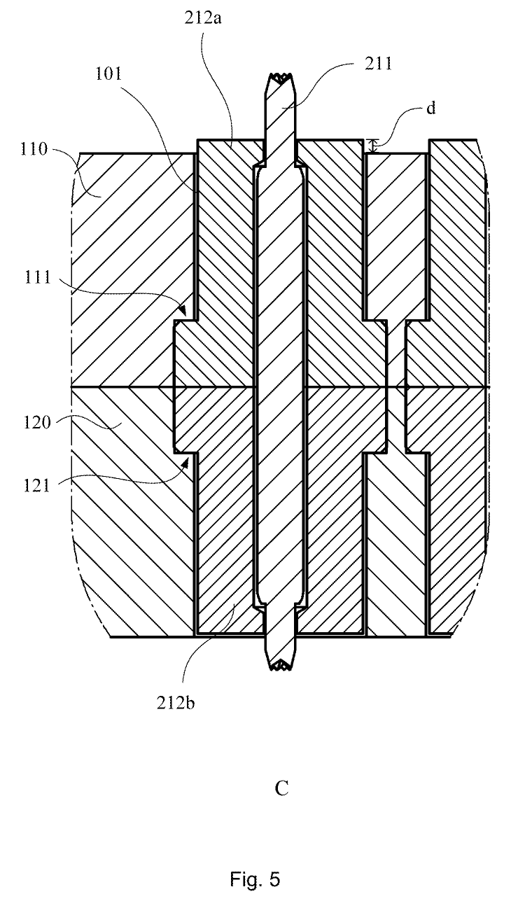

Referring to FIG. 2 through FIG. 5, there is shown in FIG. 5 a partially enlarged schematic view based on FIG. 3. A wall surface of each of the channels 101 formed in the first body 110 comprises a first step portion 111. A wall surface of each of the channels 101 formed in the second body 120 comprises a second step portion 121. The non-conductive dielectric 212 matches the first body 110 and the second body 120 and thus is divided into: a first dielectric portion 212a disposed in the channels of the first body 110, and a second dielectric portion 212b disposed in the channels of the second body 120.

The non-conductive dielectric 212 is fixed and positioned by a step portion formed on a wall surface of the corresponding one of the channels 101. The first dielectric portion 212a is prevented from detaching upwardly from the corresponding one of the channels 101 by a stopping action of the first step portion 111, and the second dielectric portion 212b is prevented from detaching downwardly from the corresponding one of the channels 101 by a stopping action of the second step portion 121. The configuration of the step portions is formed by a stepped structural variation constructed on the wall surface surrounding the corresponding one of the channels 101. Such a structural configuration also facilitates assembly and subsequent maintenance.

Referring to FIG. 3 and FIG. 5, a first dielectric portion 212a of the non-conductive dielectric 212 comprises a protruding section on an upper surface of the first body 110. This protruding section provides distance control between a contact plate (or carrier board) above the connector pin module and the upper surface of the metal body 100. When the contact plate is pressed downward to establish a contact-type electrical connection, the maximum downward pressing distance of the contact plate is limited by the protruding section of the first dielectric portion 212a and the second step portion 121. That is, the protruding section is configured to support the contact plate, thereby restricting its downward travel to maintain at least a predetermined distance between the first body 110 and the contact plate.

The degree of protrusion of the protruding section, which determines at least a predetermined distance between the carrier board and the metal body 100, also affects the quality of signal transmission. In some embodiments, the protruding section may be configured to protrude from the upper surface of the first body 110 by a height d not greater than 0.4 mm. In some embodiments, the protruding sections of the non-conductive dielectrics 212 formed on the metal body 100 may be configured such that an overall height d thereof is approximately 0.2 mm on average. In still other embodiments, the protruding section may be configured to protrude from the upper surface of the first body 110 by a height d of about 0.16 mm to about 0.24 mm.

Referring to FIG. 4, a plurality of ground connector pins 230 may further be disposed within the metal body 100. The ground connector pins 230 are received within blind holes 103 respectively, with the blind holes 103 being recessed cavities formed downwardly from an upper surface of the metal body 100. The blind holes 103 are disposed around the channels 102 respectively, and the arrayed arrangement of the blind holes 103 allows the ground connector pins 230 to be provided in proximity to the channels 102 respectively. Similarly, as in the configuration of the channels 102, approximately one half of each of the blind holes 103 may be formed in the first body 110, while the remaining portion is formed in the second body 120. In other embodiments, different allocation ratios between the first body 110 and the second body 120 may also be employed.

In some embodiments, the signal connector pin 211 and the ground connector pins 230 may both be configured as spring-loaded connector pins (Pogo Pins). The ground connector pins 230 each comprise a telescopic portion that protrudes from the corresponding one of the blind holes 103. By virtue of the aforementioned protruding section, appropriate extension of the telescopic portions of the ground connector pins 230 ensures a contact-type electrical connection between each of the ground connector pins 230 and the contact plate.

In conclusion, the connector pin module is arranged with a specific configuration and corresponding materials to reduce interference to signals and thus apply to the transmission of high-frequency signals, so as to avoid becoming a bottleneck in the improvement of transmission rate.

As used herein, the terms “approximately,” “about,” “nearly,” “substantially,” or “essentially” are generally intended to refer to any value or range that is an approximation of a given value or range. The degree of approximation may vary depending on the related field, and should be interpreted in a manner consistent with the broadest reasonable understanding of such terms by those skilled in the art, so as to encompass equivalent embodiments and all modifications resulting from such variations. In some embodiments, these terms may generally denote a variation within twenty percent (20%) of a given value or range, more typically within ten percent (10%), and still more typically within five percent (5%). Unless expressly stated otherwise, numerical values set forth herein are to be understood as approximate values, such that they fall within the scope of “approximately,” “about,” “nearly,” “substantially,” or “essentially,” or otherwise include equivalent approximate values.

The present disclosure is illustrated by various aspects and embodiments. However, persons skilled in the art understand that the various aspects and embodiments are illustrative rather than restrictive of the scope of the present disclosure. After perusing this specification, persons skilled in the art may come up with other aspects and embodiments without departing from the scope of the present disclosure. All equivalent variations and replacements of the aspects and the embodiments must fall within the scope of the present disclosure. Therefore, the scope of the protection of rights of the present disclosure shall be defined by the appended claims.

What is claimed is:

1. A connector pin module for high-frequency signal transmission, comprising:
a metal body comprising a plurality of channels extending therethrough; and
a plurality of signal transmitters disposed within the channels respectively and each comprising a signal connector pin and a non-conductive dielectric arranged around the signal connector pin such that the signal connector pin is spaced apart from a wall surface of the channel.

2. The connector pin module of claim 1, wherein the metal body comprises a first body and a second body coupled to each other, with a first step portion defined on a wall surface of each of the channels of the first body, and a second step portion defined on a wall surface of each of the channels of the second body, the non-conductive dielectric being restrained by the first step portion to prevent upward detachment and being restrained by the second step portion to prevent downward detachment.

3. The connector pin module of claim 2, wherein the first body has a periphery comprising an extension portion extending downward, and a recessed portion is defined at a bottom side of the first body by the extension portion such that the second body is disposed within the recessed portion.

4. The connector pin module of claim 2, wherein the non-conductive dielectric comprises a protruding section on an upper surface of the first body, and the protruding section is supported by the second step portion against a downward pressing force from a contact plate disposed above the protruding section to maintain a predetermined distance between the first body and the contact plate.

5. The connector pin module of claim 4, wherein each of the protruding sections protrudes from the upper surface of the first body by not more than 0.4 mm.

6. The connector pin module of claim 4, wherein each of the protruding sections protrudes from the upper surface of the first body by 0.16 mm to 0.24 mm.

7. The connector pin module of claim 4, wherein the non-conductive dielectric comprises a first dielectric portion disposed within the channel of the first body and a second dielectric portion disposed within the channel of the second body.

8. The connector pin module of claim 1, wherein the non-conductive dielectric is made of a material comprising at least polytetrafluoroethylene (PTFE).

9. The connector pin module of claim 8, wherein the metal body is made of brass or aluminum.

10. The connector pin module of claim 9, wherein the signal connector pin is a Pogo Pin.

11. The connector pin module of claim 9, further comprising a plurality of ground connector pins, wherein the metal body further comprises a plurality of blind holes disposed around the channels respectively, wherein the ground connector pins are disposed within the blind holes respectively and each comprise a telescopic portion protruding from the blind hole.

12. The connector pin module of claim 11, wherein the ground connector pins are Pogo Pins.

13. The connector pin module of claim 2, further comprising a plurality of ground connector pins, wherein the metal body further comprises a plurality of blind holes disposed around the channels respectively, wherein the ground connector pins are disposed within the blind holes respectively, wherein the blind holes each comprise an upper blind-hole portion disposed in the first body and extending therethrough and a lower blind-hole portion disposed in the second body and not extending therethrough.

14. The connector pin module of claim 13, wherein the non-conductive dielectric is made of a material comprising at least polytetrafluoroethylene (PTFE).

15. The connector pin module of claim 14, wherein the metal body is made of copper or aluminum.

16. The connector pin module of claim 15, wherein the signal connector pin and the ground connector pins are Pogo Pins.
